(19) United States
(12) Patent Application Publication
(10) Pub. No.: US 2011/0005662 A1
(43) Pub. Date: Jan. 13, 2011

(54) Method for Fabricating Multilayer Panels

(76) Inventor: Kuo-Hua SUNG, San Jose, CA (US)

Correspondence Address: APPLE c/o MOFO LA, 555 WEST FIFTH STREET SUITE 3500, SUITE 200, LOS ANGELES, CA, 90013-1024, US

(21) Appl. No.: 12/501,378

(22) Filed: Jul. 10, 2009

(51) Int. Cl. B32B 38/00

(52) U.S. Cl. 156/153; 156/250

(57) ABSTRACT

A method for fabricating a plurality of touch sensor panels is disclosed. In one embodiment, the method includes forming a plurality of touch substrate units having a plurality of drive lines and sense lines on at least one of first and second surfaces of a touch substrate mother sheet; forming an adhesive layer on the first surface of the touch substrate mother sheet covering at least part of each of the plurality of touch substrate units; affixing a cover glass mother sheet having a plurality of cover glass units to the adhesive layer of the touch substrate mother sheet to form a laminate; and separating the laminate into a plurality of panels, each panel including a touch substrate unit laminated to a cover glass unit.

### FIELD

This relates generally to the mass fabrication of multilayer panels, and more particularly, to a method of fabricating multilayer panels using an array lamination process.

### BACKGROUND

Many manufacturing processes are designed to produce a large number of panels, each of which includes multiple layers. Often, the layers are laminated together using adhesives. The fabricated multilayer panels can be used as parts of various electronic instruments and devices. For example, one type of device may be a touch screen, which has become increasingly popular in recent years because of its ease and versatility of operation as well as its declining price. Touch screens can allow a user to perform various functions by touching the touch sensor panel using a finger, stylus or other object at a location often dictated by a user interface (UI) being displayed by the display device. In general, touch screens can recognize a touch event and the position of the touch event on the touch sensor panel, and a computing system can then interpret the touch event in accordance with the display appearing at the time of the touch event, and thereafter can perform one or more actions based on the touch event.

Many currently available touch screens include a multilayer touch sensor panel. The layers in a multilayer touch sensor panel can include a cover layer (e.g., a cover glass) on top of a touch substrate layer. The cover layer can protect the underlying touch substrate from being damaged by external forces. The touch substrate is designed primarily for detecting touches by a finger or stylus on the external surface of the cover layer. Both the cover layer and the touch substrate can be made of transparent material such as glass. In some touch screens, the touch sensor panel may further include a display layer, such as an LCD panel, that can be positioned partially or fully underneath the touch substrate of the touch sensor panel so that the touch substrate overlaps with at least a portion of the viewable area of the display.

The size of touch screens (and their embedded touch sensor panels) can vary significantly depending on the display requirement of their host devices. However, regardless of whether a touch screen may be designed for a large screen monitor or a hand held mobile device, it can be beneficial for manufacturers to be able to manufacture a large number of touch screens efficiently to keep the cost low and meet production needs.

### SUMMARY

Conventionally, at least part of the touch screen fabrication process is done at a piece part level. In particular, to fabricate multilayer touch sensor panels for touch screens, full surface lamination of two or more substrates (e.g., the cover glass and the touch substrate) is performed at a piece part level where adhesive is first pre-deposited on a surface of one of the substrates and the other substrate is then affixed to the surface with the pre-deposited adhesive to form a multilayer panel. FIGS. 1A-1D illustrate the exemplary steps in a conventional piece-part level lamination process for fabricating a multilayer panel. FIG. 1A illustrates a first layer 100 of the panel before lamination. The first layer 100 may have been cut out from a mother sheet and sized according to the specification of the panel of which it will be a part. As illustrated in FIG. 1B, a layer of adhesive 102 is deposited onto the first surface 104 of the first layer 100. The amount of adhesive deposited may depend upon the surface area of the first surface 104, for example. The adhesive layer may cover at least a part of the first surface 104. Next, as illustrated in FIG. 1C, the second layer 106 is affixed to the first layer 100 so that a second surface 108 of the second layer 106 is laminated to the first surface 104 of the first layer 100 by the adhesive layer 102 pre-deposited on the first surface 104 of the first layer 100. The second layer 106 may also have been cut out from a mother sheet and fitted for the panel. As illustrated in FIG. 1C, the second surface 108 of the second layer 106 may be similar in size to the first surface 104 of the first substrate 100. As such, the two layers 100, 106 can be aligned with respect to each other prior to being laminated together using any known means. FIG. 1D shows a 2-layer panel 110 constructed by laminating the first layer 100 and second layer 106 together. In the embodiment where the panel is a touch sensor panel, the first layer may be a touch substrate and second layer may be a cover glass.

The lamination process illustrated in FIGS. 1A-1D has to be undertaken for each panel fabricated. Because the conventional method requires a lamination step in the manufacturing process of each multilayer panel, it may add to the time cost of mass-producing such panels. Thus, piece-part level processing is not well-suited for high volume fabrication of multilayer panels involving a lamination step. In addition, the conventional method may require separate cutting steps to cut each layer out from its mother sheet, adding even more delays, complexity and cost to the manufacturing process.

Embodiments of the present disclosure provide an efficient method for fabricating multilayer panels. Specifically, this relates to methods for fabricating multiple multilayer panels, such as touch sensor panels, that minimizes the number of lamination steps required. As mentioned in the preceding paragraphs, when it comes to manufacturing a large quantity of multilayer touch sensor panels, conventional processes require that each panel be made individually. Specifically, the layers of the panel have to be individually cut out from their respective mother sheets, sized in accordance with the specification of the panel, and laminated together to form the panel. Embodiments of the present disclosure eliminate at least some of the steps in the conventional process.

In general, embodiments of the present disclosure can enable large scale (i.e., high volume) fabrication of multilayer panels by performing an array lamination step at the mother-sheet level instead of multiple lamination steps at the piece-part level. The mother sheets of each layer of the multilayer panel may include one or more arrays of individual layer units to construct the multilayer panels. In one embodiment, adhesive may be pre-deposited on a surface of one of the mother sheets so that it covers each layer unit in the mother sheet. A second mother sheet may then be affixed to the first mother sheet using the pre-deposited adhesive to form a laminate that includes both mother sheets. In an embodiment where the multilayer panels to be fabricated are touch sensor panels, one or both of the first and second mother sheets may be processed to include one or more of thin film layers, masking or paint layers, and surface treatments on their surfaces. For example, the touch substrate mother sheet may be subjected to a thin film process such that each touch substrate unit in the mother sheet can be coated with thin indium tin oxide (ITO) film patterns on at least one of its surfaces. The thin film patterns on each touch substrate unit may be laid out as a grid of drive lines and sense lines that form multiple touch pixels on a capacitive touch sensor panel for detecting touches.

After the two mother sheets are laminated together, one or more post lamination processes can be performed on the laminate. Exemplary post lamination processes can include autoclaving, piece part separation, polishing treatments, electronic circuit components assembly and bonding processes, and peripheral accessories assembly. It is during those post lamination processes that the laminate is cut into multiple sections, each of which may form a multilayer panel including a layer unit from each of the mother sheets. Accordingly, by performing the lamination step at the mother-sheet level, significantly fewer lamination steps may be required to fabricate multiple multilayer panels. In addition, the number of cutting steps can also be significantly reduced because the individual mother sheet does not have to be cut prior to the lamination step. As such, embodiments of the present disclosure can significantly improve the efficiency of multilayer panel (e.g., touch sensor panel) fabrication processes and reduce manufacturing costs by allowing a large number of panels to be fabricated simultaneously in fewer steps. Furthermore, embodiments of the invention can also increase yield because fewer manufacturing steps are involved, less human handling is required, and most of the steps can be performed in an enclosed chamber, reducing contamination in the process.

### BRIEF DESCRIPTION OF THE DRAWINGS

FIGS. 1A-1D illustrate the exemplary steps in a conventional piece-part level lamination process.

FIGS. 2A-2F illustrate the exemplary steps of a multilayer touch sensor panel fabrication process according to embodiments of the disclosure.

FIG. 3A is a side view illustration of an exemplary touch substrate mother sheet having an ITO layer coated on one of its surfaces according to embodiments of the disclosure.

FIG. 3B illustrates a top view of the touch substrate mother sheet of FIG. 3A according to embodiments of the disclosure.

FIG. 4 provides a side view illustration of an exemplary multilayer touch sensor panel 400 fabricated according to the method described above in view of FIGS. 2A-2F.

FIG. 5A illustrates an exemplary digital media player having a SITO or DITO touch sensor panel fabricated according to embodiments of the disclosure.

FIG. 5B illustrates an exemplary mobile telephone having a SITO or DITO touch sensor panel fabricated according to embodiments of the disclosure.

FIG. 5C illustrates an exemplary mobile computer having a SITO or DITO touch sensor panel fabricated according to embodiments of the disclosure.

FIG. 5D illustrates an exemplary desktop computer having a SITO or DITO touch sensor panel fabricated according to embodiments of the disclosure.

FIG. 6 illustrates an exemplary computing system including a touch sensor panel fabricated according to embodiments of the disclosure.

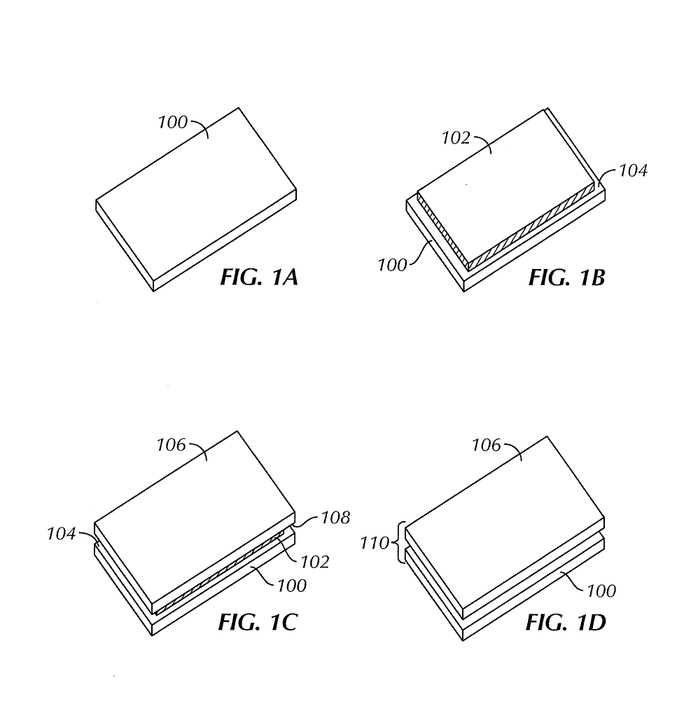

### DETAILED DESCRIPTION OF THE PREFERRED EMBODIMENTS

In the following description of preferred embodiments, reference is made to the accompanying drawings which form a part hereof, and in which it is shown by way of illustration specific embodiments in which the disclosure can be practiced. It is to be understood that other embodiments can be used and structural changes can be made without departing from the scope of the embodiments of this disclosure.

In general, embodiments of the present disclosure enable high volume fabrication of multilayer panels by performing an array lamination step at the mother-sheet level instead of multiple lamination steps at the piece-part level. The mother sheets of each layer of the multilayer panel may include one or more arrays of individual layer units to construct the multilayer panels. In one embodiment, adhesive may be pre-deposited on a surface of one of the mother sheets so that it covers each layer unit in the mother sheet. A second mother sheet can then be affixed to the first mother sheet using the pre-deposited adhesive to form a laminate that includes both mother sheets. In the embodiment where the multilayer panels to be fabricated are touch sensor panels, one or both of the first and second mother sheets may be processed to include one or more of thin film layers, masking or paint layers, or surface treatments on their surfaces. For example, the touch substrate mother sheet may be subjected to a thin film process such that each touch substrate unit in the mother sheet is coated with thin indium tin oxide (ITO) film patterns on at least one of its surfaces. The thin film patterns on each touch substrate unit may be laid out as a grid of drive lines and sense lines that form multiple touch pixels on a capacitive touch sensor panel for detecting touches.

After the two mother sheets are laminated together, one or more post lamination processes can be performed on the laminate. Exemplary post lamination processes include autoclaving, piece part separation, polishing treatments, electronic circuit components assembly and bonding processes, and peripheral accessories assembly. It is during those post lamination processes that the laminate is cut into multiple sections, each of which may form a multilayer panel including a layer unit from each of the mother sheets. Accordingly, by performing the lamination step at the mother-sheet level, significantly fewer lamination steps may be required to fabricate multiple multilayer panels. In addition, the number of cutting steps can also be significantly reduced because the individual mother sheet does not have to be cut prior to the lamination step. As such, embodiments of the present disclosure can significantly improve the efficiency of multilayer panel (e.g., touch sensor panel) fabrication processes and reduce manufacturing cost by allowing a large number of panels to be fabricated simultaneously in fewer steps. Furthermore, embodiments of the invention can also increase yield because fewer manufacturing steps are involved, less human handling is required, and most of the steps can be performed in an enclosed chamber, reducing contamination in the process.

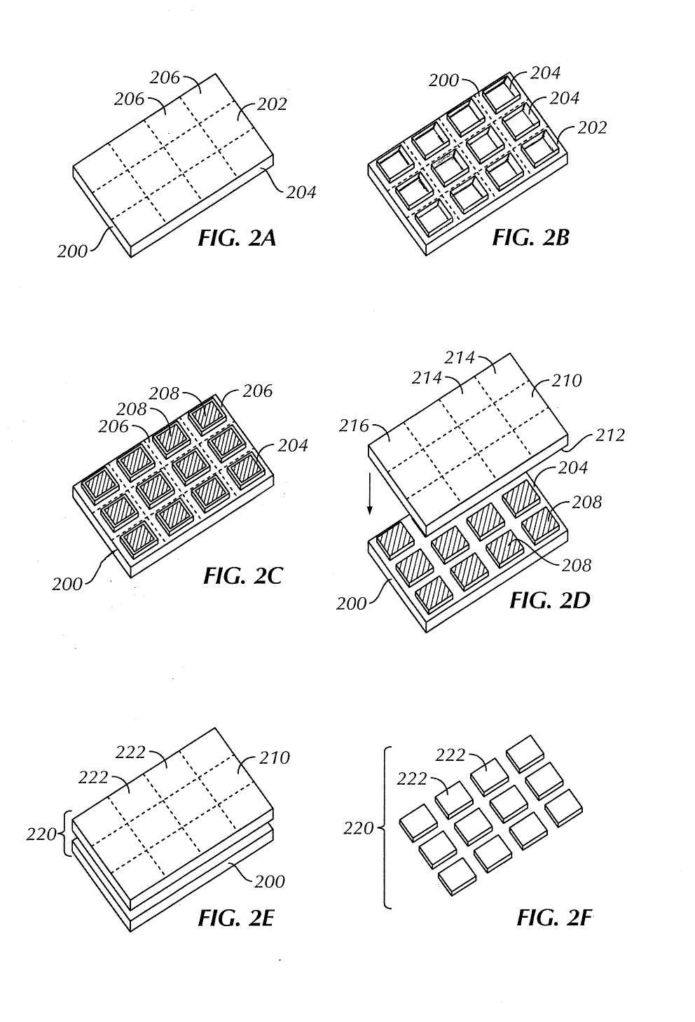

FIGS. 2A-2F illustrate the exemplary steps of a multilayer touch sensor panel fabrication process. The touch sensor panels to be fabricated can include at least a touch substrate (i.e., the first layer) and a cover glass (i.e., a second layer). To begin the fabrication process, as shown in FIG. 2A, a touch substrate mother sheet 200 is provided. In this embodiment, the touch substrate mother sheet 200 may be a rigid transparent material such as glass. In other embodiments, the mother sheet 200 may be another type of rigid substrate, such as a ceramic substrate, or a flexible substrate, such as plastic, polyimide, or polyethylene terephthalate (PET) substrate.

Depending on the type of touch sensor panel to be fabricated, the touch substrate of the panel may need to include thin film layers on one or both of its surfaces. In some configurations, touch sensor panels can be implemented as an array of pixels formed by multiple drive lines (e.g. rows) crossing over multiple sense lines (e.g. columns), where the drive and sense lines are separated by a dielectric material. In some touch sensor panels, the drive and sense lines can be formed on the top and bottom sides of the touch substrate of the panel. (See U.S. patent application Ser. No. 10/842,862, which is incorporated by reference in its entirety herein.) In other touch sensor panels, the drive and sense lines may be formed on one side of the touch substrate of the panel. (See U.S. patent application Ser. No. 12/038,760, which is incorporated by reference in its entirety herein.) The sense lines and drive lines can be formed from a substantially transparent material such as ITO, although other materials can also be used. The ITO layer(s) can be deposited on one or both sides of the touch substrate of the panel. Touch sensor panels with double or single sided ITO layers are referred to as double-sided ITO (DITO) touch sensor panels and single-sided ITO (SITO) touch sensor panels, respectively, in this document.

Although not shown in FIG. 2A, the touch substrate mother sheet 200 may be pre-processed to have one or both of its surfaces 202, 204 coated with a thin ITO layer(s). In other embodiments, the coating of ITO layers may not be performed until later in the fabrication process. Additionally, a layer of metal coating (also not shown) may be optionally applied on top of the ITO layer deposited on the surface(s) 202, 204 of the touch substrate 200.

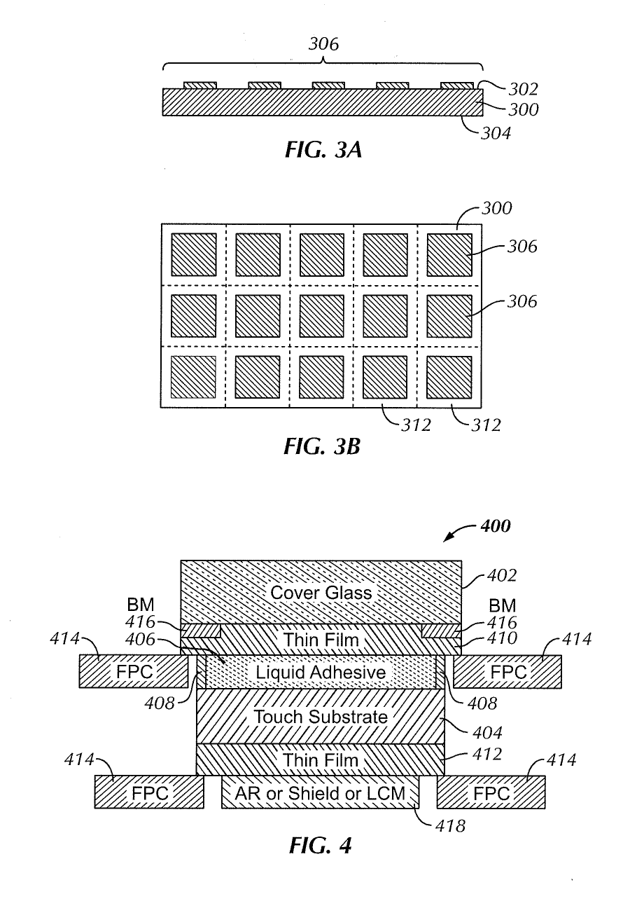

FIG. 3A is a side view illustration of an exemplary touch substrate mother sheet 300 having an ITO layer 306 formed on its top surface 302. The ITO layer 306 may be patterned to form matrices of sense lines and drive lines in individual touch substrate units (not shown) in the mother sheet 300. FIG. 3B illustrates a top view of the same touch substrate mother sheet 300 of FIG. 3A. As illustrated, the touch substrate mother sheet 300 may include an array of individual touch substrate units 312. Although an array of only three rows and five columns is shown in FIG. 3B, it is to be understood that the array may include any number of columns and rows of touch substrate units depending on the size of the mother sheet 300. Each unit 312 in the array is shown to have an ITO layer 306 coated on its surface. As mentioned above, the ITO layer may be patterned to create capacitive touch sensor pixels on the individual touch substrate units. Although FIGS. 3A and 3B only show that one surface of the touch substrate mother sheet 300 is coated with thin film, the bottom surface 304 can also be processed to include a thin film (e.g., ITO) layer. Furthermore, it is to be understood that the individual touch substrate units 312 do not have to be the same size, as illustrated in FIG. 3B. The mother sheet 302 can be designed to include touch substrate units 312 of different shapes and sizes. Accordingly, the ITO coating and patterning process can be customized to create different ITO patterns for different touch substrate units 312.

A layer of adhesive may be deposited on one of the surfaces of the touch substrate mother sheet 300. The type of adhesive deposited may include, but is not limited to, pressure sensitive adhesive (PSA), thermoplastic film, thermoset film, thermal cure liquid (single or multiple component), UV cure liquid (single or multiple component), UV/thermal combo cure liquid (single or multiple component), optically clear adhesive (OCA), optical clear gel, and room temperature cure adhesive. If a liquid adhesive, such as UV cure liquid, is to be deposited on the surface of the touch substrate mother sheet, adhesive borders outlining the space on the surface of the mother sheet in which the adhesive is to be applied may be affixed to that surface before the liquid adhesive is deposited. FIG. 2B illustrates a touch substrate mother sheet 200 having an array of borders (collectively as 204) affixed to its top surface 202. The array of adhesive borders 204 may be closely conformed to the outline of the individual touch substrate units on the mother sheet 200 so that the liquid adhesive can be deposited to cover a substantial part of the top surface of each touch substrate unit.

The material of the adhesive borders 204 can be any of the well known types of UV, temperature, or pressure cure solid adhesives. The borders 204 may have an opacity of between 0-100% depending on design requirements of the panels to be fabricated. For example, if an area covered by the borders 204 overlaps with a viewing area of an underlying display panel, a border 204 made of a substantially transparent (i.e., opacity of about 0%) material may be preferable. In various embodiments, because the borders themselves are an adhesive, they can be easily affixed to the top surface 202 of the touch substrate mother sheet 200 using well known methods such as dispensing, screen printing, coating, and the like. The process may be further broken down into a depositing step during which the adhesive borders 204 are laid down on the designated areas on the surface 202 and a curing step during which the borders 204 can become affixed to the surface 202. The border depositing step illustrated in FIG. 2B may be optional if solid adhesive instead of liquid adhesive is to be deposited on the surface of the touch substrate mother sheet 200.

In the next step, as shown in FIG. 2C, a layer of adhesive may be deposited on one of the surfaces 202 of the touch substrate mother sheet 200 such that an array of adhesive blocks 208 is formed on the surface 202, each adhesive block overlapping with an individual touch substrate unit 206 of the touch substrate mother sheet 200. As previously mentioned, the adhesive can be in either solid or liquid form. Different types of adhesive including the ones listed above can be used. If an array of borders 204 has been affixed to the surface 202, liquid adhesive 206 may be deposited by filling up the areas inside the borders 204. Alternatively, if solid adhesive is used, the adhesive may be first molded into blocks of a fixed shape (e.g., a rectangular shape of a particular size) and deposited on the surface of the touch substrate mother sheet 200 such that each block substantially overlaps with a corresponding touch substrate unit 206. In the embodiments where an ITO layer has been coated on the same surface 202 of the touch substrate mother sheet 200, the adhesive layer can be deposited on top of the ITO layer.

Although different types of adhesive may be used in the step illustrated in FIG. 2C, the selection of adhesive may depend upon the type of panel being fabricated. For example, some embodiments of the disclosure may be directed to the manufacturing of touch sensor panels for a touch screen, which typically includes a display underneath the touch sensor panel. As such, the adhesive is preferably transparent so that the viewing area of the display is not blocked by the adhesive layer. However, in other embodiments, adhesive with different opacity may be used. Similar to the processes listed above for affixing the adhesive borders to the mother sheet surface, the adhesive layer can be deposited using well known methods such as dispensing, screen printing, and coating. A specific method may be selected based on the type of adhesive being deposited. Optionally, a pre-cure process may be performed by applying thermal or UV treatment to the surface 204 of the first substrate 200. As will be discussed in detail below, the adhesive layer 208 is used to laminate the touch substrate mother sheet and a cover glass mother sheet.

It is to be understood that one of the features of this embodiment of the disclosure is that the adhesive layer is deposited on the touch substrate mother sheet 200 in one step. This eliminates the time-consuming repetitive process of depositing adhesive on the surface of each individual touch substrate cut from the mother sheet at a piece-part level that is part of the conventional touch panel fabrication process. For example, if done at a piece-part level, it would require 20 separate adhesive depositing steps to put adhesive on 20 touch substrates cut from the same mother sheet. In contrast, only one step is required if the depositing step is performed at a mother-sheet level using the method disclosed according to embodiments of the present disclosure.

Referring to FIG. 2D, after the adhesive 208 is deposited on the top surface 204 of the touch substrate mother sheet 200, a cover glass mother sheet 210 can be laminated to the touch substrate mother sheet 200 using the adhesive 208. The cover glass mother sheet 210 may include an array of cover glass units 214. As previously mentioned, each cover glass unit 214 will form a second layer of a touch sensor panel upon completion of the fabrication process. The cover glass layer is primarily a protective layer that protects the underlying layer(s) such as the touch substrate layer. Here, the cover glass mother sheet 210 can be a rigid transparent substrate such as glass. In other embodiments, the cover glass mother sheet 210 may be other rigid material or a flexible substrate such as plastic, polyimide, PET, etc. The cover glass mother sheet 210 may or may not be the same material as the touch substrate mother sheet 200.

The cover glass mother sheet 210 can also be pre-processed before being laminated to the touch substrate mother sheet 200. For example, the cover glass mother sheet 210 may also undergo a thin film process to include one or more layers of thin film (patterned or not) on its bottom surface 212 (i.e., the surface to be brought in touch with the adhesive). The one or more layers of thin film may include a patterned ITO layer and a metal layer. Additionally or alternatively, the top surface 216 of the cover glass mother sheet 208 may be coated with a protective mask or a paint layer. For example, because the top surface 216 of the cover glass of a touch sensor panel is where touches occur, an anti-scratching layer may be added to that surface to prevent damage to the surface. In various embodiments, one or more surface treatments can be performed on the surfaces of the cover glass mother sheet 210.

Referring again to FIG. 2D, the cover glass cover mother sheet 210 may be a substantially planar sheet that is similar in dimensions to the touch substrate mother sheet 200. Specifically, the bottom surface 212 of the glass cover mother sheet 210 may substantially overlap with the top surface 204 of the touch substrate mother sheet such that during lamination they can be easily aligned by their respective edges. Additionally or alternatively, the two mother sheets 200, 210 can be aligned based on detectable marks on their respective surfaces. Aligning of the two mother sheets prior to lamination can eliminate the need to repeat the lamination process. When the mother sheets 200, 210 are properly aligned, the arrays of individual units in the two mother sheets 200, 210 are also aligned.

The two mother sheets can be brought together by any of the well known methods such as by applying pressure with or without added conditions such as vacuum, thermal treatment, UV treatment, or any combination of the above. In particular, as the bottom surface 212 of the cover glass mother sheet 210 is brought into contact with the adhesive layer (e.g., the arrays of adhesive blocks 206 illustrated in FIG. 2C) deposited on the top surface 204 of the touch substrate mother sheet 200, the external pressure may press the two mother sheets 200, 210 towards each other, causing the two mother sheets 200, 210 to be laminated together using the adhesive between their respective surfaces 204, 212.

FIG. 2E illustrates an exemplary laminate 220 including the two mother sheets 200, 210. The laminate includes a plurality of multi-layered sections 222, each including a top layer comprising a unit of the cover glass mother sheet 210 and a bottom layer comprising a unit of the touch substrate mother sheet 200 with a layer of adhesive (not shown) between them. The sections 222 of the laminate 220, once separated from the rest of the sheet, become a part of an individual touch sensor panel. Details of the separating (i.e., cutting step) step are described in the next paragraph. Although the sections 222 of the laminate 200 are shown in FIG. 2E to be of the same size and shape and arranged in an array, it is to be understood that they can also be of different sizes and shapes and arranged in other patterns based on how the mother sheets 200, 210 are designed.

In the next step, as illustrated in FIG. 2F, the laminate 220 is divided into a plurality of sections 222 using any known cutting and/or breaking means. For example, the laminate 220 may be first cut by a cutter (not shown). Cutting may be performed based on wheel scriber, laser scriber, liquid jet scriber, or other known scribing methods after ensuring that the cutter is aligned properly to cut along the boundary lines between adjacent sections 222. In one embodiment, the cutter cuts through the laminate in a direction substantially perpendicular to the top surface of the laminate. Once the cutting is finished, individual sections 222 may be broken off from the rest of the mother sheet using manual methods, automated methods, machine or fixture assisted methods, or any other known breaking methods. FIG. 2F illustrates the separated sections 222 as a result of the cutting/breaking step. Each of the sections 222 includes a layer including a unit from the touch substrate mother sheet 200 (shown as the bottom layer) laminated to another layer including a section of the cover glass mother sheet 210 (shown as the top layer). In some embodiments, the two layers of each section cut from the laminate may form a touch sensor panel.

In some embodiments, the laminate 220 may be further subjected to post lamination processes including, but not limited to, post affixation curing and autoclaving. In addition, the exemplary laminating process illustrated in FIGS. 2B-2E may be repeated to add one or more additional layers to the laminate before the laminate is cut into pieces. Each additional layer can be another mother sheet for a separate layer in the device to be fabricated. For example, an AR film, a shield film, or a liquid crystal monitor (LCM) can be laminated to the bottom surface of the touch substrate (i.e., the surface on which the liquid adhesive is deposited).

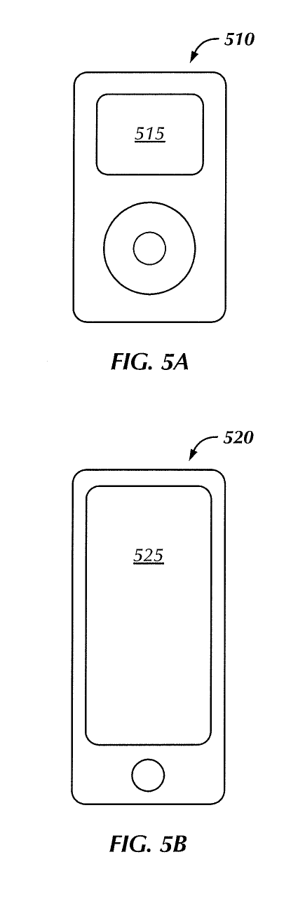

FIG. 4 provides a side view illustration of an exemplary multilayer touch sensor panel 400 fabricated according to the method described above in view of FIGS. 2A-2F. The touch sensor panel 400 includes a top cover glass 402 laminated to a touch substrate 404 using liquid adhesive 406 deposited on top of the touch substrate 404. The liquid adhesive 406 is sealed between the cover glass layer 402 and the touch substrate layer 404 with one or more edge seals 408. The edge seals 408 may be the adhesive borders described above. The cover glass 402 and the touch substrate 404 were individual units of the cover glass mother sheet and the touch substrate mother sheet, respectively, prior to the lamination and cutting process disclosed above in view of FIGS. 2A-2F. In this embodiment, the cover glass 402 and the touch substrate 404 can be cut into slightly different dimensions. For example, as illustrated in FIG. 4, the width of the cover glass 402 can be longer than that of the touch substrate 404. To accomplish this, during the cutting step, unwanted sections from each layer may be stripped using any known methods. Both the cover glass 402 and the touch substrate 404 can then be ground and polished to produce smoother edge and/or surfaces.

In some embodiments as described above, thin film layers can be coated on the bottom surface of the cover glass 402 and the bottom surface of the touch substrate 404 separated by the touch substrate 404 and the liquid adhesive layer 406. The two thin film layers may be patterned ITO layers that form drive and sense lines of a capacitive touch sensor. The drive lines may be formed in the thin film layer 410 coated on the bottom surface of the top cover 402 and the sense lines may be formed in the thin film layer 412 coated on the bottom surface of the touch substrate 404, or vice versa. In other embodiments, by putting the drive and sense lines on different surfaces of the touch substrate 404, the touch substrate 404 can become a DITO capacitive touch sensor panel that is capable of sensing touches on the top surface of the cover glass 402.

One or more flexible printed circuits (FPCs) 414 can be bonded to the edge of one or both of the thin film layers 410, 412 (e.g., the drive and sense lines) so that the FPCs 414 can be electrically connected to the drive and sense lines of the thin film layers. This can allow the FPC to measure the changes in capacitance between each crossing of a drive line and a sense line in those thin film layers 410, 412. The measured changes can be processed to determine whether a touch has occurred at certain locations on the top surface of the cover glass 402. Also illustrated in FIG. 4 is black mask 416 (a type of cosmetic plate) formed on the bottom surface of the cover glass 402 and around the outer edge of the thin film layer 410 prior to laminating the cover glass to the touch substrate. The black mask 416 is typically opaque and can be used to keep the non-transparent FPCs and edge seal 408 beneath it hidden from a user's view.

In some embodiments, an additional layer of AR film, shield film, or LCM 418 may be formed on the bottom of the touch sensor panel 400, formed over the thin film layer 412 on the bottom surface of the touch substrate 404 prior to lamination with the cover glass. A shield film 418 may be used to block interfering electrical fields in the vicinity of the touch substrate 404 so that the measured capacitance data can accurately represent the characteristics of one or more touches detected on the top surface of the top cover 402. A LCM 418 can be used as the display of the touch screen. Because the cover glass 402, the thin film layers 410, 412, the liquid adhesive 406, and the touch substrate 404 can all be formed from substantially transparent material, the middle part of the touch sensor panel 400 where the black mask 416 does not reach may be substantially see-through. This can allow the LCM display 418 underneath the touch sensor panel 400 to be visible from above the top cover 402.

Although the embodiments disclose above is directed to fabricating multiple 2-layer touch sensor panels by performing lamination on the mother-sheet level and then cutting the laminate into individual panels, a person skilled in the art may use the same method to fabricate any kind of 3 or more layered panels.

One of the features of the disclosure resides in the mother-sheet level lamination step. Because each mother-sheet may include a large number of units, laminating two mother sheets prior to cutting the laminate can be far more efficient than laminating units from the same mother sheets at the piece part level. According to embodiments of the disclosure, the number of lamination steps can be directly related to the number of layers to be laminated rather than the number of individual units being fabricated. Because the number of layers in a panel is typically much less than the number of units in a mother sheet, embodiments of the disclosure can provide an efficient way of fabricating multilayer panels by performing lamination of the layers at the mother-sheet level.

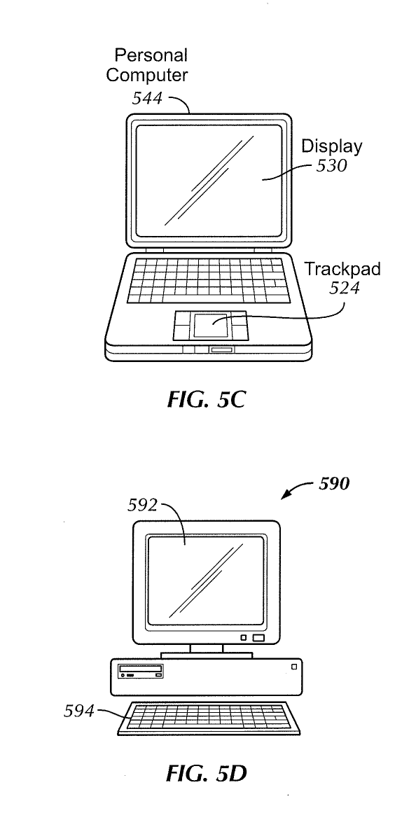

FIG. 5A illustrates exemplary digital media player 510 that can include thin touch sensor panel 515 fabricated according to embodiments of the disclosure.

FIG. 5B illustrates exemplary mobile telephone 520 that can include thin touch sensor panel 525 fabricated according to embodiments of the disclosure.

FIG. 5C illustrates an exemplary personal computer 544 that can include touch sensor panel 524 and display device 530. The touch sensor panel 524 can be a SITO/DITO panel fabricated according to embodiments of the disclosure.

FIG. 5D illustrates a desktop computer 590 including a display device 592. The display device 592 may include a SITO/DITO panel fabricated according to embodiments of the disclosure. The desktop computer 590 may also include a virtual keyboard 594 which incorporates a SITO/DITO panel fabricated according to embodiments of the disclosure.

The devices (or parts of the devices) of FIGS. 5A-5D can be mass produced using embodiments of the disclosure.

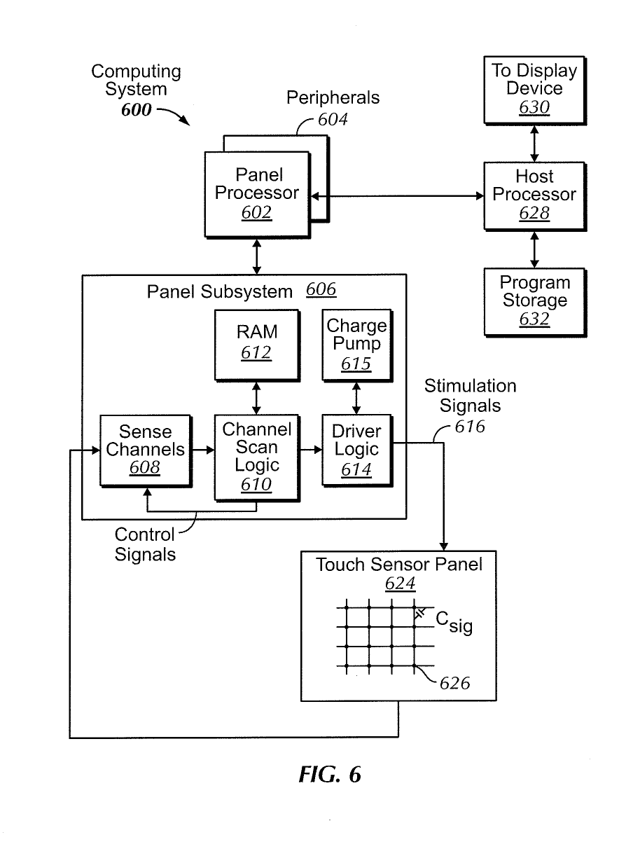

FIG. 6 illustrates exemplary computing system 600 that can include one or more DITO or SITO touch sensor panels fabricated according to the embodiments of the disclosure described above. Computing system 600 can include one or more panel processors 602 and peripherals 604, and panel subsystem 606. Peripherals 604 can include, but are not limited to, random access memory (RAM) or other types of memory or storage, watchdog timers and the like. Panel subsystem 606 can include, but is not limited to, one or more sense channels 608, channel scan logic 610 and driver logic 614. Channel scan logic 610 can access RAM 612, autonomously read data from the sense channels and provide control for the sense channels. In addition, channel scan logic 610 can control driver logic 614 to generate stimulation signals 616 at various frequencies and phases that can be selectively applied to drive lines of touch sensor panel 624. In some embodiments, panel subsystem 606, panel processor 602 and peripherals 604 can be integrated into a single application specific integrated circuit (ASIC).

Touch sensor panel 624 can include a capacitive sensing medium having a plurality of drive lines and a plurality of sense lines, although other sensing media can also be used. Either or both of the drive and sense lines can be coupled to a thin glass sheet according to embodiments of the disclosure. Each intersection of drive and sense lines can represent a capacitive sensing node and can be viewed as picture element (pixel) 626, which can be particularly useful when touch sensor panel 624 is viewed as capturing an “image” of touch. (In other words, after panel subsystem 606 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel).) Each sense line of touch sensor panel 624 can drive sense channel 608 (also referred to herein as an event detection and demodulation circuit) in panel subsystem 606.

Computing system 600 can also include host processor 628 for receiving outputs from panel processor 602 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 628 can also perform additional functions that may not be related to panel processing, and can be coupled to program storage 632 and display device 630 such as an LCD panel for providing a UI to a user of the device. Display device 630 together with touch sensor panel 624, when located partially or entirely under the touch sensor panel, can form touch screen 618.

Note that one or more of the functions described above can be performed by firmware stored in memory (e.g. one of the peripherals 604 in FIG. 6) and executed by panel processor 602, or stored in program storage 632 and executed by host processor 628. The firmware can also be stored and/or transported within any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any medium that can contain or store the program for use by or in connection with the instruction execution system, apparatus, or device. The computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A method for fabricating a plurality of touch sensor panels, comprising:
forming a plurality of touch substrate units having a plurality of drive lines and sense lines on at least one of first and second surfaces of a touch substrate mother sheet;
forming an adhesive layer on the first surface of the touch substrate mother sheet covering at least part of each of the plurality of touch substrate units;
affixing a cover glass mother sheet having a plurality of cover glass units to the adhesive layer of the touch substrate mother sheet to form a laminate; and
separating the laminate into a plurality of panels, each panel including a touch substrate unit laminated to a cover glass unit.

2. The method of claim 1, wherein forming the adhesive layer further comprises:
depositing borders to divide the first surface into a plurality of regions; and
depositing adhesive in each of the plurality of regions,
wherein the adhesive is liquid adhesive.

3. The method of claim 2, wherein the borders are solid adhesive.

4. The method of claim 1, wherein adhesive in the adhesive layer is one of PSA, thermoplastic film, thermoset film, thermal cure liquid, UV cure liquid, UV/thermal combination cure liquid, OCA, optical clear gel, and room temperature cure adhesive.

5. The method of claim 1, wherein affixing the cover glass mother sheet to the touch substrate mother sheet to form a laminate is performed by applying pressure.

6. The method of claim 1, further comprising:
laminating a shield film mother sheet including a plurality of shield film units to one of the first and second surfaces of the touch substrate mother sheet before separating the laminate.

7. The method of claim 1, further comprises autoclaving the laminate.

8. The method of claim 1, wherein separating the laminate is performed using one of a wheel scriber, a laser scriber, and a liquid jet scriber.

9. The method of claim 1, further comprising grinding and polishing each of the plurality of panels.

10. The method of claim 1, further comprising bonding at least one FPC onto at least one of the cover glass unit and the touch substrate unit of each of the plurality of panels.

11. The method of claim 1, further comprising incorporating one of the touch sensor panels with a display device to form a touch screen.

12. The method of claim 1, further comprising incorporating one of the touch sensor panels into a mobile telephone.

13. The method of claim 1, further comprising incorporating one of the touch sensor panels into a media player.

14. The method of claim 10, further comprising incorporating one of the touch sensor panels into a media player.

15. A method for fabricating a plurality of touch sensor panels, comprising:
providing a touch substrate mother sheet having a first surface and a second surface, the touch substrate mother sheet including a plurality of touch substrate units;
providing a cover glass mother sheet having a third surface and a fourth surface, the cover glass mother sheet including a plurality of cover glass units;
performing thin film processing on at least one surface of the touch substrate mother sheet to form a plurality of drive lines and sense lines;
depositing an adhesive layer on the first surface of the touch substrate mother sheet, the adhesive layer covering at least a part of each of the plurality of touch substrate units;
affixing the cover glass mother sheet to the touch substrate mother sheet to form a laminate, wherein the third surface of the cover glass mother sheet is in contact with the first surface of the touch substrate and the adhesive layer is between the third surface and the first surface; and
separating the laminate into a plurality of panels, each panel including a touch substrate unit laminated to a cover glass unit.

16. A method for fabricating a plurality of piece parts, comprising:
performing thin film processing on at least one of first and second surfaces of a substrate mother sheet to form a plurality of substrate units;
forming an adhesive layer on the first surface of the substrate mother sheet, the adhesive layer covering at least a part of each of the plurality of substrate units;
affixing a cover glass mother sheet having a plurality of cover glass units to the adhesive layer of the substrate mother sheet to form a laminate; and
separating the laminate into a plurality of piece parts, each piece part including a substrate unit laminated to a cover glass unit.
